(19) United States
(12) Patent Application Publication
(10) Pub. No.: US 2009/0268586 A1
(43) Pub. Date: Oct. 29, 2009

(54) Objective Lens Unit and Optical Pickup Apparatus

(76) Inventors: Kazuhiro Wada, Tokyo (JP); Hiroyuki Hattori, Tokyo (JP); Yuichi Atarashi, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/992,994

(22) PCT Filed: Oct. 4, 2006
(86) PCT No.: PCT/JP2006/319831

§ 371 Date: Apr. 1, 2008

(30) Foreign Application Priority Data
Oct. 4, 2005 (JP) 2005-291299

(51) Int. Cl. G11B 7/135; G02B 7/02

(52) U.S. Cl. 369/112.23; 359/811; 359/813; G9B/7.112

(57) ABSTRACT

An objective lens unit for use in an optical pickup device, includes: a first lens section; a first flange section positioned peripheral of the first lens section; and a support section which supports a second objective lens having a second lens section provided in parallel to the first lens section with an optical axis different from that of the first lens section, wherein the first lens section, the first flange section and the support section are integrally formed.

### TECHNICAL FIELD

The present invention relates to an objective lens unit and an optical pickup apparatus equipped with the objective lens unit suitable as an object system for an optical pickup.

### BACKGROUND

Until now, various optical pickup apparatuses for performing playback and record of information from and to optical information recording media, such as CD (compact disk) and a DVD (digital versatile disc), have been developed and manufactured, and have become widely popularized. Here, “playback and record of information” denotes the playback and/or record regarding information. With regard to an objective lens, which will be built into this optical pickup apparatus, there is a compound objective lens having a plurality of lens elements inserted and fixed into a holder. This optical pickup apparatus can easily perform playback and record of information from and to different types of recording media (refer to patent documents 1). In addition, there is the compound objective lens into which compound lens elements are integrally formed as the same type of objective lens. In this case, assembly processes will become easy since the compound objective lens is miniaturized by the integral formation (Refer to patent documents 2-5). In addition, there is an objective lens, which is formed so that two micro lenses having different focal lengths respectively might be embedded on the glass substrate of a relatively low refractive index (refer to patent documents 6).

Patent documents 1: Unexamined Japanese patent Application Publication No. 2001-67700 official report

Patent documents 2: Unexamined Japanese patent Application Publication No. H09-115170 official report

Patent documents 3: Unexamined Japanese patent Application Publication No. H09-306012 official report

Patent documents 4: Unexamined Japanese patent Application Publication No. H10-275356 official report

Patent documents 5: Unexamined Japanese patent Application Publication No. H09-63083 official report

Patent documents 6: Unexamined Japanese patent Application Publication No. 2000-90472 official report

### DISCLOSURE OF THE INVENTION

### Subject to be Solved by the Present Invention

However, in case of the compound objective lens having a plurality of lens elements inserted and fixed into a holder, the objective lens becomes large, an assembly process easily becomes complicated, and especially, the eccentricity adjustment among the plurality of lens elements becomes less easy.

On the other hand, in the case of the compound objective lens having integrally formed plurality of lens elements, the objective lens can relatively be miniaturized easily, and the assembly process can also be achieved easily at a low cost. However, it is not easy to make all of each optical surface of the plurality of lens elements with high precision by a resin forming. That is, in the case of the above-mentioned compound objective lenses, in order to make each surface with high precision, it is necessary to prepare many dies individually having at least four different optical surfaces. Thus, it becomes extremely difficult to align each die against the other, and making a highly precise compound objective lens, which is a product, becomes less easy.

Further, in the case of the objective lens formed so that two micro lenses might be embedded into the glass substrate of a relatively low refractive index, an assembly process is extremely complicated and the degree of freedom of the optical characteristic, which can be set to the objective lens obtained as a result, will also be restricted.

Thus, an object of the present invention is to provide an objective lens unit for an optical pickup apparatus used for a compatible application, and the objective lens unit for making small and highly precise image-formation possible and for realizing the easy and low cost assembly process.

Another object of the present invention is to provide an optical pickup apparatus for compatibility and for realizing low cost and high record and playback accuracy.

### Means to Solve the Problems

The above-described objects of the present invention were attained by the following structure.

1. An objective lens unit for an optical pickup apparatus includes a first lens section, a first flange section located on a periphery of the first lens section, and a supporting section for supporting a second objective lens equipped with a second lens section, which is arranged in parallel with the first lens section so that an optical axis of the second objective lens section differs from an optical axis of the first objective lens, wherein the first lens section, the first flange section and the supporting section are integrally formed.

2. The objective lens unit of item 1, wherein the second objective lens has a second flange section provided in a periphery of the second lens section.

3. The objective lens unit of item 2, wherein the supporting section supports a light source side surface of the second flange section.

4. The objective lens unit as in either item 2 or item 3 further includes a holder for supporting at least any one of the first flange section, the second flange section and the supporting section.

5. The objective lens unit of item 4, wherein the holder is integrally formed with at least either the first lens section or the second lens section.

6. The objective lens unit of any one of items 1 to 5, wherein the second objective lens is fixed onto the supporting section.

7. The objective lens unit of any one of items 1 to 6, wherein the supporting section further includes an alignment device for aligning the second flange section against the supporting section.

8. The objective lens unit of item 7, wherein the alignment device has a mechanism for positioning the second lens section in an optical axis direction and in a direction, which is perpendicular to the optical axis direction.

9. The objective lens unit of any one of items 1 to 8, wherein spot-diameter of the first lens section and the second lens section are respectively different from each other.

10. The objective lens unit of any one of items 1 to 9, wherein the supporting section has a function as an aperture of the second lens section.

11. The objective lens unit of any one of items 1 to 10, wherein the second objective lens is formed with glass.

12. An objective lens unit for an optical pickup apparatus includes a first member, which has a first lens section and a first flange section for supporting a periphery of the first lens section by being integrally formed with the first lens section, and a second member having a second lens section and a second flange section for supporting a periphery of the second lens section by being integrally formed with the second lens section, wherein the first flange section supports the second member so that the second lens section adjoins the first lens section.

13. The objective lens unit of item 12, wherein the first flange section supports a light source side surface in of the second flange section.

14. The objective lens unit of either item 12 or item 13 further includes a holder for supporting either the first flange section or the second flange section.

15. The objective lens unit of item 14, wherein the holder is integrally formed with at least either the first lens section or the second lens section.

16. The objective lens of any one of items 12 to 15, wherein the second lens is fixed onto the first flange section.

17. The objective lens unit of any one of items 12 to 16, wherein the first flange section further includes an alignment device for aligning the second flange section against the first flange section.

18. The objective lens unit of item 17, wherein the alignment device has a mechanism for positioning the second lens section in an optical axis direction and in a direction, which is perpendicular to the optical axis direction.

19. The objective lens unit of any one of items 12 to 18, wherein spot-diameter of the first lens section and the second lens section are respectively different from each other.

20. The objective lens unit of any one of items 12 to 19, wherein the first flange section has a function as an aperture of the second lens section.

21. The objective lens unit of any one of items 12 to 20, wherein the second objective lens is formed with glass.

22. An optical pickup unit includes:

the objective lens of any one of items 1 to 12; and

an optical device for reading information from a first optical information recording medium or for writing information onto the first optical information recording medium, and for reading information from a second optical information recording medium or for writing information onto the second optical information recording medium.

23. The optical pickup apparatus of item 22, further includes a drive device for driving the objective lens unit to displace the first lens section and the second lens section.

### EFFECT OF THE INVENTION

According to the present invention, small and highly precise image-formation becomes available, and it becomes possible to provide an objective lens unit for compatibility, which realize easy assembly process with low cost and the optical pickup apparatus, which realizes high record and playback accuracy by using the objective lens unit.

### BRIEF DESCRIPTION OF THE DRAWINGS

FIGS. 1(a) and 1(b) illustrate front views of an objective lens unit of a first embodiment, and FIG. 1(c) illustrates a side view of the objective lens unit.

FIG. 2 illustrates a plan view of a lens assembly including the objective lens unit shown in FIG. 1.

FIG. 3 illustrates a figure showing a configuration of an optical pickup apparatus into which the lens assembly shown in FIG. 1 is inserted.

FIG. 4 illustrates a side sectional view of a configuration of an objective lens unit of a second embodiment.

FIG. 5 illustrates a plan view of a configuration of an objective lens unit of a third embodiment.

FIG. 6 illustrates a plan view of a configuration of an objective lens unit of a fourth embodiment.

FIG. 7 illustrates a figure showing a configuration of an objective lens unit of a fifth embodiment.

FIG. 8 illustrates a figure showing a configuration of a lens assembly of a sixth embodiment.

FIGS. 9(a) and 9(b) illustrate perspective diagrams explaining a configuration and an assembly of a lens unit of a seventh embodiment.

FIG. 10 illustrates a side view of the lens unit of the seventh embodiment.

FIG. 11 illustrates a side view of a modification of the lens unit shown in FIG. 10.

### DESCRIPTION OF SYMBOLS

10, 110, 210, 310, and 410: OBJECTIVE LENS UNIT
31: FIRST LENS SECTION
21: SECOND LENS SECTION
40: HOLDING MEMBER
61B, 61D, and 61C: SEMICONDUCTOR LASER
63B, 63D, 63C, 64D, and 64C: POLARIZATION BEAM SPLITTER
67B, 67C, and 67D: PHOTODETECTOR
71 and 72: ACTUATOR PORTION
73: ACTUATOR
75: SUPPORTING APPARATUS
DB, DD, and DC: OPTICAL DISC
MB, MD, and MC: INFORMATION RECORDING SURFACE

### BEST MODE FOR ACHIEVING THE PRESENT INVENTION

In order to solve the above-mentioned subject of the present invention, an objective lens unit for an optical pickup apparatus pertaining to the present invention is an objective lens unit integrally forming (a) a first lens section, (b) a first flange section positioned in surrounding of the first lens section and (c) a supporting section for supporting a second objective lens including a second lens section arranged parallel to the first lens section so that an optical axis may differ from the first lens section.

In the above-mentioned objective lens unit, since the supporting section provided on the first objective lens having the first lens section and the first flange section by integrally forming supports a second objective lens, the second lens section can be arranged close to the first lens section. Not only switching the lens switching and arranging either lens section onto an optical path becomes easy, but also the objective lens unit can be miniaturized. In addition, the first objective lens and a second objective lens can be manufactured independently, respectively. A first lens section or a second lens section can be produced relatively easily with high precision, and formed with different materials.

Moreover, in the specific embodiment or viewpoint of the present invention, the second objective lens is equipped with a second flange provided in the periphery of the second lens section in the above-mentioned objective lens unit. In this case, a secure support of the second lens section may be attained.

In another embodiment of the present invention, the supporting section supports a surface of a light source side of the second flange. In this case, a disposition of the supporting section closer to an optical information recording medium than the second flange can be prevented, and a security of a working distance becomes easy.

In another embodiment of the present invention, a holder supporting at least one of the first flange section, the second flange section, and the supporting section is further equipped. In this case, since the first lens section and the second lens section can be displaced with a holder, and a drive of the objective lens unit and treatment become convenient.

In another embodiment of the present invention, the holder and at least either one of the first lens section or the second lens section are integrally formed. In this case, an adhesion process of the objective lens or the objective lens unit and the holder becomes unnecessary, and the number of parts or cost can be reduced.

In another embodiment of the present invention, the second objective lens is fixed to the supporting section. In this case, depending on which lens section will be disposed on the optical path, the first or the second lens section, a reproduction and recording of the information can be simply performed to two kinds of optical information recording media having different standard specifications.

In another embodiment of the present invention, the supporting section is further equipped with an alignment device to align the second flange section to the supporting section. In this case, a connection and a fixation of the second lens section and the supporting section extending from the first lens section become easy, and the simple and highly precise assembly of the objective lens unit becomes possible. In addition, with regard to the above-mentioned alignment device, the alignment device can further include a mechanism for positioning the second lens section in the direction perpendicular to the poetical axis.

In addition, the first member and a second member, which configure an objective lens unit, can be formed from the various resins, which can usually be used for the optical application of a lens. It is desirable to use resin containing the polymer, which has alicyclic structure especially, and it is more desirable to use cyclic olefin based resin.

In addition, athermal resin can also be used as a material of the above resin. Athermal resin is the material having parent material, into which particles of 30 nm or less are distributed. Since athermal resin has the feature that the refractive index change to a temperature change is small, compared with resin of the usual optical application, in cases where phase structure is formed in a first lens section or a second lens section, it becomes possible to make the improving effect of the temperature characteristics by the phase structure moderate. Thereby, the deterioration of the wavelength characteristic by the phase structure can be reduced, the design freedom degree of an optical element can be extended, or the tolerance of a manufacture error or assembly precision can be expanded.

Since dispersion of light would arise and permeability would generally fall when mixing of the powder is carried out to a transparent resin material, it was difficult to use it as an optical material. However, when using impalpable powder having mean particle diameter smaller than the wavelength of transmitted light flux, for example, a particle of 30 nm or less, it has been studied that it becomes possible eventually not to generate dispersion. By using such a phenomenon, the material from which temperature characteristics differ is uniformly mixable macroscopically. Furthermore, it can control that the temperature change of a refractive index or thermal expansion becomes remarkable. The material, which gives such an artificial temperature-characteristics depression effect, is called athermal resin. With regard to athermal resin, the material into which a particle having a mean diameter of 30 nm or less is distributed is preferable and the rate of a refractive index of which is larger than the rate of refractive index change accompanying the temperature change of resin used as a parent material. Here, the thing that whose the rate of a refractive index change is large is that in cases where the sign of the rate of a refractive index change of resin used as a parent material is negative, it includes both of a negative rate of a refractive index change near to zero than the negative rate, and a positive rate of a refractive index change.

In another embodiment of the present invention, the above-mentioned first lens section and the above-mentioned second lens section can have different diameters respectively. In this case, reproduction and record of information can be simply performed to two kinds of optical information recording media having different spot-diameter on an information recording surface having different kinds of standards.

In another embodiment of the present invention, a supporting section has a function as a aperture of a second lens section. In this case, it becomes unnecessary to provide the aperture for second lens sections individually, and reduction of number of parts and reduction of cost can be promoted. Simultaneously, the optical pickup apparatus incorporating an objective lens unit can be miniaturized.

In another embodiment of the present invention, the above-mentioned second objective lens is formed by glass. In this case, the optical precision of the performance against the environmental temperature change of a second objective lens, etc. can be increased, and an objective lens unit can be included in various optical pickup apparatuses.

Another objective lens unit related to the present invention has (a) a first member including a first lens section and a first flange section, which supports the circumference of the first lens section by being integrally formed with the first lens section, (b) a second member including a second lens section and the second flange section, which supports the circumference of the second lens section by being integrally formed with the second lens section, (c) wherein the above-mentioned first flange section supports the above-mentioned second member so that it may be in the status that the above-mentioned first lens section adjoined the above-mentioned second lens section.

In the above-mentioned objective lens unit, since the adjacent arranging of the first lens section and the second lens section can be carried out on the first supporting section, reproduction and record of information can be simply performed to two or more kinds of optical information recording media having different kinds of standard, depending on which lens section will be disposed on the optical path, the first or the second lens section. And since the first supporting section can support a second member in a first member in the case of this objective lens unit, the close arrangement of a first lens section and a second lens section is possible. Further, the lens change, which changes one of lens sections on an optical path and arranges them, can not only become easy, but it can miniaturize an objective lens unit. In addition, the first member and the second member can be respectively manufactured independently, and the first lens section and the second lens section can be manufactured with high precision.

The optical pickup apparatus related to the present invention includes (a) the above-mentioned objective lens unit, (b) an optical apparatus, which reads the information on the first optical information recording medium through a first lens section, or writes information in the first optical information recording medium, and reads the information on the second optical information recording medium through a second lens section, or writes information in the second optical information recording medium.

With the above-mentioned optical pickup apparatus, the above-mentioned objective lens unit is used and reproduction and record of information can be simply performed to two or more kinds of different optical information recording media. In addition, since the supporting section, which is integrally formed with the first objective lens, supports the second objective lens, the close arrangement of the first lens section and the second lens section is possible, and a lens change not only becomes easy, but also the offer of a small objective lens unit becomes available.

In addition, in a concrete embodiment of the present invention, above-mentioned optical pickup further includes a driving device, which drives an objective lens unit and displaces the first and the second lens section. In this case, while the change between the first and the second lens section is attained, the tracking and focusing of each lens section can be performed using this driving device.

Hereafter, although embodiments of the present invention will be described by using figures, the present invention is not limited to these illustrated figures.

### First Embodiment

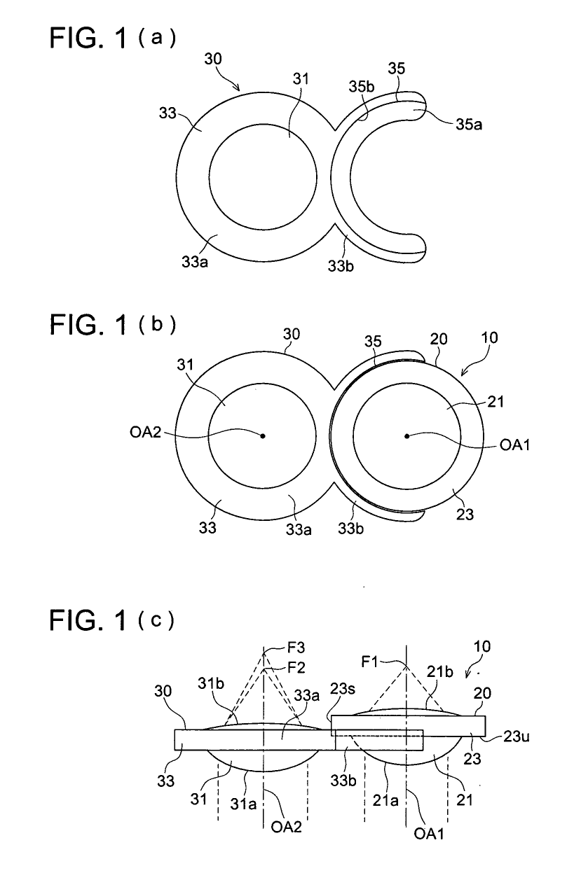

An objective lens unit related to a first embodiment of the present invention will be described by referring to drawings hereafter. Here, FIG. 1(a) illustrates a floor plan explaining the objective lens unit of the first type, and FIGS. 1(b) and 1(c) are the floor plan and a side view of the objective lens unit of the second type where the second objective lens is attached onto the objective lens unit of FIG. 1(a).

The first member 30 illustrated in FIG. 1(a) etc. is an objective lens unit, which functions as an objective lens by itself. The first member 30 has the first lens section 31, which converges the light flux, which enters into the first lens section 31 in the collimated status into a spot having a relatively large diameter, and the double supporting section 33, which supports the second member 20, which will be described later, in the upper portion and supports the first lens section 31 from the circumference at the same time. The first member 30 is a single part, which is collectively formed, for example, from the plastic material, and the first lens section 31 and the double supporting section 33 are integrally formed. Here, although the first lens section 31 is circular, the double supporting section 33 has an un-circular outline by which a flange section 33a, which is formed in the circumference of the first lens section 31 and a half-circular section 33b, which supports the second member 20 from the circumference are connected. In the above objective lens unit 10, the half-circular section 33b can also be regarded as the portion, which extends the flange section 33a around the first lens section 31.

A step 35 for alignment, which is an alignment device, is formed in the half-circular section 33b along the circle. A bottom 35a of the step 35 for alignment supports the undersurface 23u of the second flange 23 of the second member 20. The side wall surface 35b of the step 35 for alignment restricts movement in the transverse direction perpendicular to an optical axis against the side surface 23S of the second flange 23 of the second member 20. Here, the bottom surface 35a faces to the optical information recording medium side, and it is a surface of the light information recording medium side of the half-circular section 33b. A gap used for position fine tuning can also be provided between the side wall surface 35b and Side 23S. At the time of an assembly, the undersurface 23u of the second flange 23 adheres the bottom 35a of the step 35 for alignment with UV curing type adhesives etc. Or, the side surface 23S of the second flange 23 adheres the side wall surface 35b of the step 35 for alignment with UV curing type adhesives etc. The second member 20 and the first member 30 can be aligned by this, and can be joined.

Although the second member 20 illustrated in FIG. 1(b) etc. functions as an objective lens by itself, it is used under the condition that the second member 20 is supported by the first member 30. The second member 20 has the second lens section 21, which converges the light flux entering into the second section 21 with the status that it has been collimated, into a spot having a relatively small diameter, and the second flange 23 that supports the second lens section 21 from the circumference. This second member 20 is a single part collectively formed, for example, from the plastic material or the glass material, and the circular second lens section 21 and the second circular flange 23 are integrally formed have a circular outline.

The objective lens unit 10, into which the first and the second members 30 and 20 have been joined and integrally formed, serves as a composite objective lens, which were explained above, is arranged to be switched and placed opposite to one of a plurality kinds of optical discs (not shown). That is, incident light can be converged to the information recording surface provided with the comparatively large spot-diameter onto the optical disc, which is an un-illustrated optical information recording medium by the first lens section 31 of the first member 30, which is the first objective lens. Incident light can also be converged to the information recording surface provided on another type of optical disc with the comparatively small spot-diameter by the second lens section 21 of the second member 20, which is a second objective lens. Here, in this objective lens unit 10, the flange section 33a supports the first lens section 31 directly, and the half-circular section 33b also supports the second lens section 21 indirectly through the second flange 23. As a result, the first and the second lens sections 21 and 31 will be arranged along a specific plane (surface parallel to the space of FIG. 1(a)) perpendicular to OA1 and OA2 being each optical axis under the condition that there are placed side by side.

Hereinafter, the functions of the first and the second lens sections 31 and 21 will be described. The first lens section 31 is designed for the laser beam having a wavelength of 655 nm for DVD, and the laser beam having a wavelength of 780 nm for CD. That is, when laser beam flux parallel to optical-axis OA2 having wavelength of 655 nm enters into the first lens section 31, for example, along with optical-axis OA2 from the undersurface 31a side of the first lens section 31 as shown in FIG. 1(c), laser beams flux having a wavelength of 655 nm will be emitted from the upper surface 31b side of first lens section 31. This laser beam flux is converged onto the focal point F2 (on the information recording surface of un-illustrated DVD) on optical-axis OA2, and forms comparatively large converging spot here. In addition, when laser beam flux parallel to optical-axis OA2 having wavelength of 780 nm enters the second lens 31 from the undersurface 31a side of the second lens 31, laser beam flux having a wavelength of 780 nm will be emitted from the upper surface 31b side of the first lens section 31. This laser luminous flux is converged to the focal point F3 (on the information recording surface of un-illustrated CD) on optical-axis OA2, and forms further larger converging spot than the converging spot of DVD here.

On the other hand, the second lens section 21 is designed for the wavelength of 405 nm for Blue-ray Discs (hereinafter it will be only called BD), or an about 408 nm laser beam. That is, in case when laser beam flux parallel to optical axis OA1 having wavelength of 405 nm enters into the second lens section 21 along optical axis OA1 from the undersurface 21a side of the second lens section 21, for example, as illustrated in FIG. 1(c), the laser beam flux is emitted from the upper surface 21b side of the second lens section 21. This laser beam flux is converged onto the focal point F3 (on the information recording surface of un-illustrated BD) on optical-axis OA1, and forms comparatively small converging spot here.

Hereafter, the material for manufacturing the first member 30 and the second member 20 will be explained. That is, both the members 30 and 20 can be formed from the material, which can usually be used for an optical application. That is, the first member 30 is formed from various resin materials etc., and the second member 20 is formed from various resin materials, a glass material, etc. In cases where both the members 30 and 20 are formed from a resin material, it is desirable to use the resin material, which contains especially the polymer of cyclic olefin based resin, which has alicyclic structure.

In addition, athermal resin can also be used as a material of both the members 30 and 20. Athermal resin is a resin material in which particles of 30 nm or less are distributed into the parent material. Generally, when temperature rises, the refractive index of the resin material used as a parent material will be reduced. However, the refractive index change as the whole material can be reduced by distributing an inorganic particle and mixing.

In cases where athermal resin is used, the refractive index change which was about −1.2×10⁻⁴ can be suppressed to less than 8×10⁻⁵ in an absolute value. However, the performance of both the members 20 and 30 namely, an objective lens unit 10, can be improved more by making a refractive index change into further less than 6×10⁻⁵ in an absolute value.

It is preferable that the refractive index change is made less than 4×10⁻⁵ in an absolute value. As a material of both the members 30 and 20, to the resin material used as a parent material, by utilizing a material into which micro sized particles formed from an inorganic particle etc. which have the refractive index characteristic of the tendency, which offsets the refractive index change of a parent material, the micro-sized particle being not more than 30 nm, preferably, not more than 20 nm, further preferably, of 10 to 15 nm, the optical element having no temperature dependency of a refractive index, or reduced temperature dependency can be offered.

In addition, as for the particles to be distributed into a parent material, it is desirable that the particle is an inorganic substance, and it is further preferable that the particle is an oxide. And it is still more desirable that it is an oxide, which the oxidation state is saturated and does not oxidize any more.

The fact that the particle is an inorganic substance is desirable from a viewpoint that reaction with resin used as the parent material, which is a macromolecule organic compound, can be suppressed low. In addition, by the fact that the particle is an oxide, the deterioration accompanying actual use, such as a laser beam exposure, can be prevented. In particular, the severe conditions such as high-temperature and laser beams are irradiated, oxidation of resin tends to easily be promoted. However, if it is the particles of such an inorganic oxide, deterioration by oxidation can be prevented.

In addition, in order to prevent oxidation of resin by other factors, of course, it is also possible to add an antioxidant in a resin material.

With regard to the example of athermal resin, the particles of niobium oxide (Nb₂O₅) can be distributed into an acrylate resin. Resin used as a parent material is 80, and niobium oxide is about 20 in a volume ratio, and these are mixed uniformly. Particles have the problem of being easy to condense. However, required distributed status can be produced with the technology of giving a charge to the particle surface, and distributing them. Instead of niobium oxide, particles of silicon oxide (SiO₂) may be used.

As for the process of mixing and dispersion of particles with the resin material used as a parent material, it is desirable to carry out on in-line process at the time of the injection molding of both the members 20 and 30. In other words, it is desirable that it is made not to be cooled and solidified after mixing and distributing until it is formed into both the members 20 and 30.

In addition, as for the above-mentioned volume ratio, in order to control the rate of the change to the temperature of a refractive index, it is possible to be able to fluctuate suitably, to blend two or more kinds of particles, and to also make it distribute. That is, in the above-mentioned example, a volume ratio is 80:20, namely, 4:1. However a volume ratio can be suitably adjusted between 90:10 (9:1) and 60:40 (3:2). The effect of temperature change restraint becomes large by making quantity of particles more than 9:1. On the contrary, by making quantity of particles less than 3:2, a problem does not arise in the formability of an optical element, which is desirable.

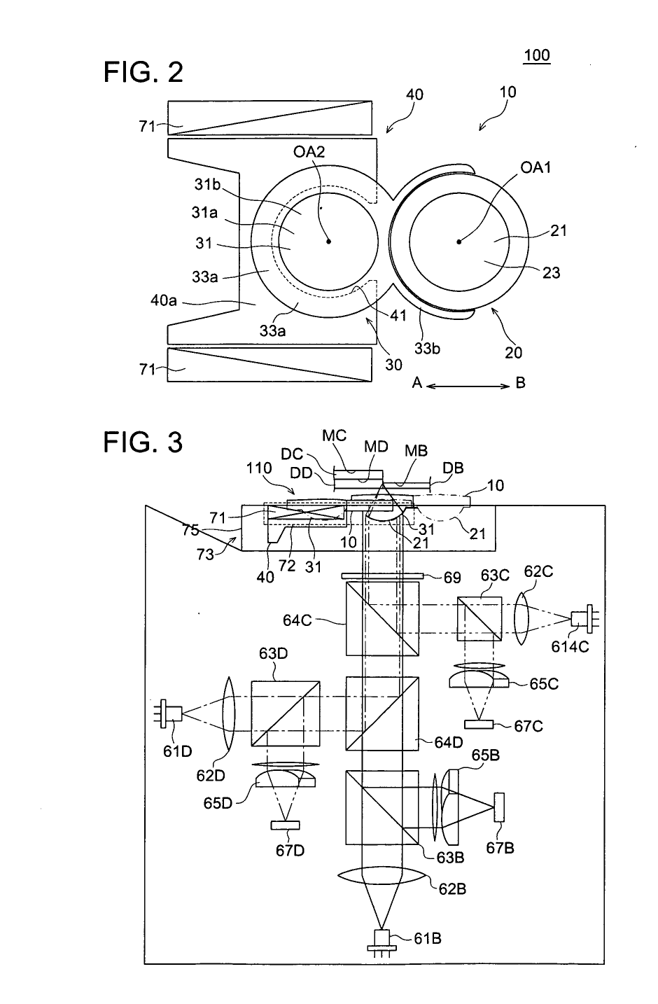

FIG. 2 is a plan view explaining the structure of the lens assembly body 100 having a holder into which the objective lens unit 10 illustrated in FIGS. 1(b) and 1(c) have been assembled. The lens assembly body 100 is equipped with the objective lens unit 10 illustrated in FIG. 1(b), the holding member 40 supporting this objective lens unit 10, which is arranged to displace with the objective lens unit 10 and two actuator sections 71, which are formed by coils etc., are fixed onto the side face of the holding member 40.

The holding member 40 is the component formed from the plastic material etc., and supports a portion of the side of the first lens section 31 of the objective lens units 10 on the top face 40a. The holding member 40 has opening 41 and supports the flange section 33a of first lens section 31 periphery by the edge portion of opening 41. The edge portion of opening 41 and the flange section 33a of the first lens section 31 are mutually fixed, for example by the UV cure type adhesive bond etc., and the objective lens unit 10 and the holding member 40 can be fixed under the condition that the objective lens unit 10 is aligned to the holding member 40. In addition, as long as the configuration of opening 41 cannot bar the support of the flange section 33a, cannot interfere with the undersurface 31a of the first lens section 31 and does not shade the incidence light to the undersurface 31a, the shape of the opening 41 can be freely designed and the step etc., which simplify the alignment of the objective lens unit 10, can also be provided. As for the holding member 40, since the actuator portion 71 is heated by the generation of heat in many cases, it is desirable to be formed with material with low thermal conductivity so that the heat conduction to the actuator portion 71 is reduced. The holding member 40 is desirable to be formed with a heat resisting material with a small coefficient of linear expansion so that it may prevent that driving accuracy falls by thermal transformation.

The actuator 71 is formed by the coil etc., which has been fixed onto the holding member 40 or integrated with the holding member 40. The actuator 71 can allow the holding member 40 to carry out the minute displacement at a high speed in a focusing direction along the optical axis OA2 and OA1, and in a tracking direction vertical to the optical axis OA2 and OA1. In addition, the actuator section 71 can greatly move the holding member 40 in the AB direction within the field where both the lens sections 31 and 21 are located in a line with the first and the second lens sections 31 and 21 by an interaction with the above-mentioned un-illustrated actuator portion. Furthermore, the actuator section 71 can selectively change the position of both the lens sections 31 and 21, on the single optical path for the target pickup.

In addition in the example illustrated in FIG. 2, the holding member 40 is supporting the portion of the side of the first lens section 31 of the objective lens units 10. However, the holding member 40 can also support the portion of the side of the second lens section 21 of the objective lens units 10. In addition, in the example illustrated in FIG. 2, the back side of the drawing (optical-information-recording-medium side) of the objective lens unit 10 is supported by the holding member 40. However, the front surface side of the drawing (light source side) of the objective lens unit 10 can also be supported by the holding member 40. In the event that the holding member 40 supports the light source side of the objective lens unit 10, it can be simply avoided that the holding member 40 projects from the objective lens unit 10 in the optical-information-recording-medium side. Therefore, the working distance of the lens assembly body 100 to an optical information recording medium can be set up greatly.

In cases where laser light having a wave length of 655 nm for DVD is guided into the first lens section 31 from the light source side in this lens assembly body 100 under the condition of having arranged the first lens section 31 in the operating position, which is on the optical path for pickup by the position control of the holding member 40, the laser light, which passed through the first lens section 31, is converged so that it may become a comparatively big spot-diameter with the comparatively small numerical aperture 0.65 onto the information recording surface (equivalent to the focal point F2 of (c) of FIG. 1) of DVD. In addition, the laser light, which passed through the first lens section 31 in the condition of having arranged the first lens section 31 on an optical path, in cases where laser light having a wave length of 780 nm for CD is guided into the first lens section 31 from the light-source side, is converged so that the laser light may become a further bigger spot-diameter with the further smaller numerical aperture 0.53 onto the information recording surface (equivalent to the focal point F3 of (c) of FIG. 1) of CD. On the other hand, in this lens assembly body 110, in the condition of having arranged the second lens section 21 on an optical path with the position control of the holding member 40, in cases where laser light having a wave length of 405 nm for Blue-ray Discs is guided into this second lens section 21 from the light-source side, the laser light which passed through the second lens section 21 is converged so that the laser light may become a comparatively small spot-diameter with the comparatively big numerical aperture 0.85 onto the information recording surface (equivalent to the focal point F1 of (C) of FIG. 1) of BD.

As it has been disclosed above, in the lens assembly body 100 incorporating the objective lens unit 10 of this embodiment, since the first lens section 31 and the second lens section 21, which have different specifications, are arranged side by side, it becomes possible to form spots, which respectively comply with a specification of the information recording surface of DVD or CD and the information recording surface of BD, by arranging either the first and the second lens sections 31 or 21 on an optical path. Under the present circumstances, the spot-diameter formed onto the information recording surface of DVD or CD of the first lens section 31 are 0.87 and 1.2 μm, respectively, and the spot-diameter formed onto the information recording surface of BD of the second lens section 21 is about 0.41 μm. In addition, in the objective lens unit 10 explained above, since the second member 20 is supported by the double supporting section 33 of the first member 30, proximity arrangement of the first lens section 31 and the second lens section 21 is possible, and the lens change, which changes one of the lens sections 31 and 21 on an optical path and arranges them, becomes easy, and the objective lens unit 10 can be miniaturized. Thereby, a highly precise optical pickup apparatus with less power consumption can be provided.

In addition, although the first member 30 and the second member 20, which configure the objective lens unit 10, are integrally formed with plastic molding and other materials respectively, both the members 30 and 20 can be formed by using a relatively simple die. In concrete, in the case of the first member 30, fundamentally, the moving mold which unified the die surface corresponding to undersurface 31a etc. and the die surface corresponding to the half-circular section 33b undersurface, and the fixed mount type which unified the die surface corresponding to a top face of 31b, etc. and the die surface corresponding to a half-circular section 33b top face can perform a precise molding like a former type. Here, with regard to the first member 30, since the difficulty of die manufacturing or a forming step increases because of providing the half-circular section 33b, it is desirable to use an optical element having a relatively low accuracy requirement. From this viewpoint, the first lens section 31 of the first member 30 is used as the objective lens for DVD or CD, and the second lens section 21 of the second member 20 is used as the objective lens for BD.

FIG. 3 roughly illustrates the structure of the optical pickup apparatus incorporating the objective lens unit 10 illustrated in FIG. 1.

In this optical pickup apparatus, the laser light from each semiconductor lasers 61B, 61D, and 61C is irradiated onto the optical discs DB, DD, and DC, which are optical information recording media, by using the common objective lens unit 10, and the reflected light from each optical disc DB, DD, and DC is eventually led to each photo detectors 67B, 67D, and 67C through the common objective lens unit 10. In addition, other than the above-mentioned semiconductor lasers 61B, 61D, and 61C, the photo detectors 67B, 67D, and 67C, etc, the optical system containing the polarization beam splitters 63B, 63D, 63C, 64D, and 64C, cylindrical lenses 65B, 65D, and 65C, and ¼ wavelength-plate 69 functions as an optical device for performing record and playback of information to each optical disc DB, DD, and DC.

Here the first semiconductor laser 61B emits the laser light for information playback of the first optical disc DB (the wave length of 405 nm for example, for BD). This laser light is converged by the second lens section 21 of the objective lens unit 10 positioning at the first operating position (position at a solid line), and a spot corresponding to NAO.85 is formed on the information recording surface MB. The second semiconductor laser 61D emits the laser light for information playback of the second optical disc DD (the wave length of 655 nm for example, for DVD), and after that laser light is converged by the first lens section 31 of the objective lens unit 10 in the position of the second operating position (at a alternate long and short dash line), and a spot corresponding to NAO.65 is formed on information recording surface MD. The third semiconductor laser 61C emits the laser light for information playback of the third optical disc DC (wave length of 780 nm for example, for CD), and after that laser light is converged by the first lens section 31 of the objective lens unit 10 in the second operating position, and a spot corresponding to NAO.53 is formed on the information recording surface MC. On the other hand, the first photo detector 67B detects the information recorded on the first optical disc DB as a light signal (the wave length of 405 nm for example, for BD). The second photo detector 67D detects the information recorded on the second optical disc DD as a light signal (the wave length of 655 nm for example, for DVD). The third photo detector 67C detects the information recorded on the third light disc DC as a light signal (the wave length of 780 nm for example, CD). In addition, when changing a light source from the first semiconductor laser 61B to the second and the third semiconductor lasers 61D and 61C, the actuator 73, which is a drive unit, slides the objective lens unit 10, which is a lens assembly body 100, to the position of an alternate long and short dash line, and the first lens section 31 is arranged on an optical path instead of the second lens section 21.

The detailed structure of the optical pickup apparatus of FIG. 3, and the concrete operation will be described hereafter. In cases where the first optical disc DB is playback, laser light having a wave length of 405 nm is emitted, and the light flux emitted from the first semiconductor laser 61B is shaped into a parallel light flux by a collimator 62B. After this light flux passes through the polarization beam splitters 63B, 64D, and 64C and ¼ wavelength plate 69, it is converged by the second lens section 21, which corresponds the first optical disc, among the objective lens units 10 onto the information recording surface MB of the first optical disc DB.

The light flux, which was modulated by the information bit and reflected by the information recording surface MB, passes through the second lens section 21 again, and it enters into the polarization beam splitter 63B. The light flux is reflected here, and astigmatism is given by a cylindrical lens 65B. Then the light flux enters into the first photo detector 67B, and the reading signal of the information recorded on the first optical disc DB is acquired using the output signal.

In addition, the light amount change by the shape change and a position change of the spot on the first photo detector 67B is detected to conduct focusing (focusing) detection and track detection. Based on this detection, the actuator 73 moves the objective lens unit 10, namely, a second lens section 21, in the direction of an optical axis, so that image-formation of the light flux from the first semiconductor laser 61B is carried out onto the information recording surface MB of the first optical disc and the second lens section 21 is moved in the direction vertical to an optical axis so that image-formation from this first semiconductor laser 61B is carried out onto a predetermined track. In addition, the actuator 73 for performing focusing and tracking includes the first actuator sections 71 attached to the holding member 40 side of the lens assembly body 100, and the second actuator portion 72 attached to the support apparatus 75 side, which guides the movement of the holding member 40 and the objective lens unit 10, and operates under control of a control device (not illustrated).

Next, in cases where the second optical disc DD is played back, laser light having a wave length of 655 nm is emitted from the second semiconductor laser 61D, and the emitted light flux is turned into a parallel light flux by a collimator 62D. After this light flux passes through the polarization beam splitter 63D, and the light flux is reflected by the polarization beam splitter 64D and it passes through the polarization beam splitter 64C etc. After that, the light flux is converged onto information recording surface MD of the second optical disc DD by the first lens section 31, which corresponds to the second optical disc, among the objective lens units 10.

The light flux, which, was modulated by the information bit and reflected by the information recording surface MD, passes through the first lens section 31 again, and it is reflected by the polarization beam splitter 64D, and enters into the polarization beam splitter 63D. The light flux is reflected here, and astigmatism is given by a cylindrical lens 65D. Then the light flux enters into the second photo detector 67D, and the reading signal of the information recorded on the second optical disc DD is acquired using the output signal.

In addition, like the case of the first optical disc DB, the light amount change by the shape change and a position change of the spot on the second photo detector 67D is detected to conduct focusing (focusing) detection and track detection. And the actuator 73 moves the objective lens unit, that is, the first lens section 31 for focusing and tracking.

Next, in cases where the third optical disc DC is played back, the light flux having a wave length of 780 nm is emitted from the third semiconductor laser 61C, for example, and emitted the light flux is shaped into a parallel light flux by the collimator 62C and passes through the polarization beam splitter 63C. Then the light is reflected by the polarization beam splitter 64C. After that the light is converged onto the information recording surface MC of the third optical disc DC by the first lens section 31, which corresponds to the third optical disc, in the objective lens units 10.

The light flux, which was modulated by the information bit and reflected by the information recording surface MC passes through the first lens section 31 again, and the light flux is reflected by the polarization beam splitter 64C, and enters into the polarization beam splitter 63C. The light flux is reflected here, and astigmatism is given by a cylindrical lens 65C. Then the light flux enters into the third photo detector 67C, and the reading signal of the information recorded on the third optical disc DC is acquired using the output signal.

In addition, like the case of the first and the second optical discs DB and DD, the light amount change by the shape change and a position change of the spot on the second photo detector 67C is detected to conduct focusing (focusing) detection and track detection. And the actuator 73 moves the objective lens unit 10, that is, the first lens section 31 for focusing and tracking.

In addition, the above is description in the case of playing information from optical disc DB, DD, and DC. However, information is also recordable on optical disc DB, DD, and DC by adjusting the output of the semiconductor lasers 61B, 61D, and 61C etc.

### Second Embodiment

Hereafter, an objective lens unit pertaining to a second embodiment will be described. Here, the objective lens unit related to an second embodiment is modified from the objective lens unit of an first embodiment, and may be taken as the same thing as an first embodiment about the part which is not explained in particular.

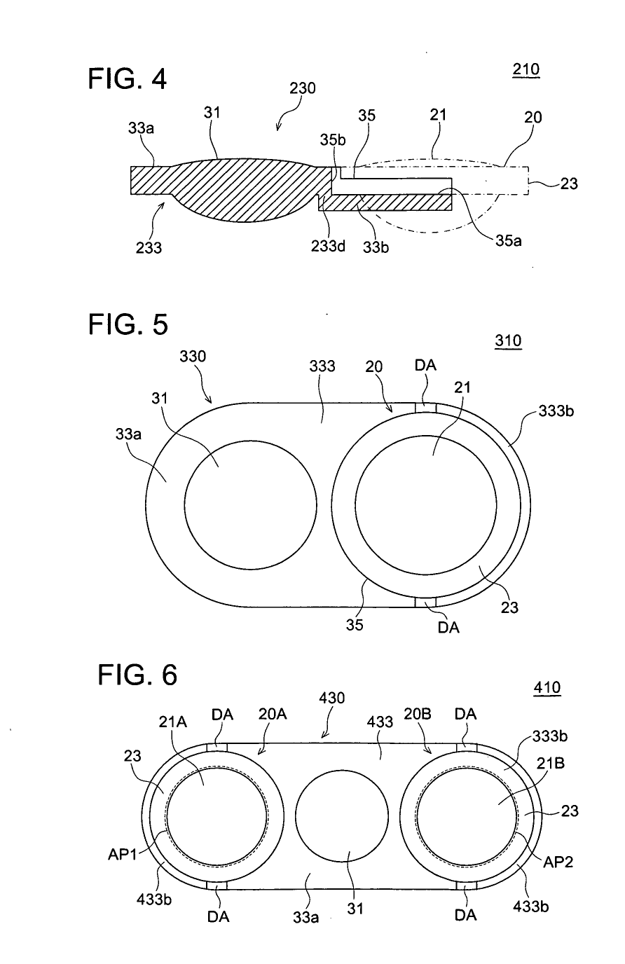

FIG. 4 illustrates a side sectional view of the objective lens unit 210 of an embodiment of this invention. In the objective lens unit 210 in FIG. 4, the stairway-like level difference of 233d is formed between a flange section 33a and a half-circular section 33b, which configure a double supporting section 233 of a first member 230. By preparing such a level difference of 233d, the relative location regarding the direction of an optical axis of the first lens section 31 and the second lens section 21 can be adjusted. In addition, the optical-axis perpendicular direction of the first lens section 31 and the second lens section 21 can be easily positioned with high precision by butting and positioning the side face of the flange section 23 of the second member 20 to the side wall surface 35b.

### Third Embodiment

A third embodiment of the objective lens unit will be described hereinafter. In addition, the objective lens unit related to a third embodiment is one, which has been modified from the objective lens unit of a first embodiment, and is taken as the same thing as first embodiment about the portion which is not explained in particular.

FIG. 5 illustrates a plan view of the objective lens unit 310 of an embodiment of the present invention. In the objective lens unit 310 illustrated in FIG. 5, the double supporting section 333 prepared in the first member 330 is equipped with the flange section 33a and the circular section 333b. As it is apparent from FIG. 5, the second member 20 is supported by the circular section 333b prolonged from the first member 330 from the periphery. In addition, the same step 35 for alignment as the first embodiment is formed in the circular section 333, and precise positioning with the first member 330b and the second member 20 is attained. In addition, an adhesive reservoir DA used when the second member 20 is fixed with adhesive is provided in the circular section 333b.

### Fourth Embodiment

A fourth embodiment of the objective lens unit will be described hereinafter. Here, the objective lens unit related to a fourth embodiment is one, which has been modified from the objective lens unit of a first embodiment, and is taken as the same thing as first embodiment about the portion which is not explained in particular.

FIG. 6 illustrates a plan view of the objective lens unit 410 of an embodiment of the present invention. In the objective lens unit 410 in FIG. 6, a double supporting section 433 of the first member 430 is prolonged on both sides of the first lens section 31, and is equipped with the central flange section 33a and both sides, a first and a second circular sections 433b and 433b. The first and the second circular sections 433b and 433b are respectively equipped with openings AP1 and AP2 so as to pass lights. As it is apparent from FIG. 6, a pair of the second member 20A and 20B is supported by the circular section 433b and 433b provided on the first member 430. In this case, one, the first lens section 31 and two, the second lens sections 21A and 21B, are arranged and are fixed mutually as an alignment. In addition, it is assumed that the second lens section 21A will be used for BD, for example, and the second lens section 21B of another side will be used for DVD. In this case, the first lens section 31 will be used for CD.

### Fifth Embodiment

A fifth embodiment of the objective lens unit will be described hereinafter. Here, the objective lens unit related to a fifth embodiment is one, which has been modified from the objective lens unit of a first embodiment, and is taken as the same thing as first embodiment about the portion which is not explained in particular.

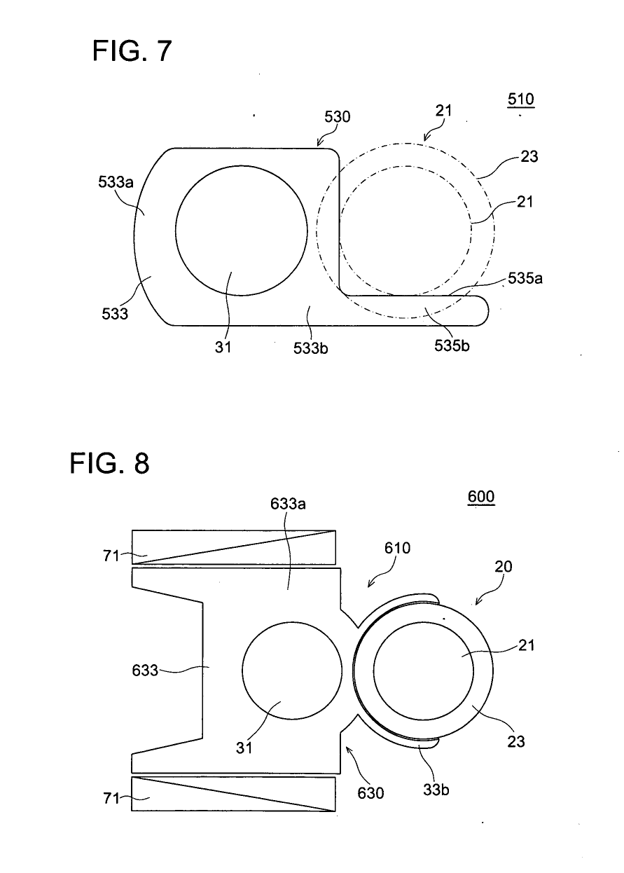

FIG. 7 illustrates a plan view of the objective lens unit 510 of an embodiment of the present invention. In the objective lens unit 510 in FIG. 7, the double supporting section 533 of the first member 530 is equipped with the circular section 533a which supports the first lens section 31 from a periphery, and the L character-like section 533b which aligns and supports the second member 20, namely, the second lens section 21. The side face 535a and the top face 535b of the L character-like section 533b function as an alignment device, which aligns and supports the second member 20.

### Sixth Embodiment

Hereinafter, the lens unit and the lens assembly body of a sixth embodiment will be described. Here, the objective lens unit related to a sixth embodiment is one, which has been modified from the objective lens unit of a first embodiment, and is taken as the same thing as first embodiment about the portion which is not explained in particular.

FIG. 8 is a plan view of the lens assembly body 600 of this embodiment. In the lens assembly body 600 in FIG. 8, the first member 630 of the objective lens unit 610 has a configuration, which serves as the holding member 40 illustrated in FIG. 2. That is, the second supporting section 633 of the first member 630 is equipped with the holder section 633a and the half-circular section 33b. In this case, the actuator section 71 is directly attached to the second member 630 side of the objective lens unit 610, that is, a holder section 633a. Since the number of parts is reduced and the adhesion process of an objective lens unit and a holder becomes and unnecessary, reduction of cost can be achieved.

### Seventh Embodiment

Hereinafter, the lens unit of a seventh embodiment will be described. Here, the objective lens unit related to a seventh embodiment is one, which has been modified from the objective lens unit of a first embodiment, and is taken as the same thing as first embodiment about the portion which is not explained in particular.

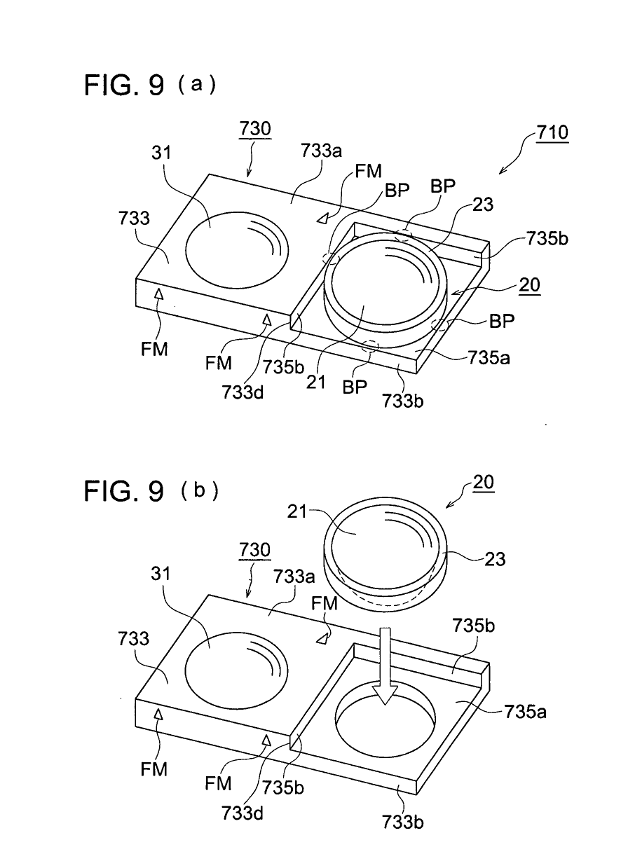

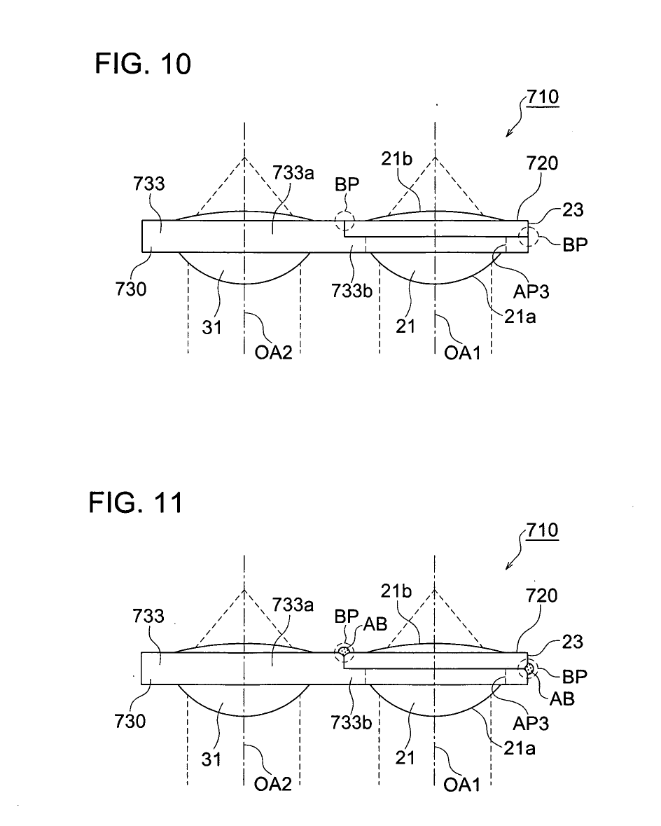

FIG. 9(a) illustrates a perspective view of the objective lens unit of this embodiment, and FIG. 9(b) illustrates a perspective view explaining an assembly of the objective lens unit 710 illustrated in FIG. 9(a). Further, FIG. 10 illustrates a side view of the objective lens unit 10. In the objective lens unit 710 illustrated in FIG. 10, the step for alignment of 733d of the shape of a stairway, which becomes depressed toward the light source side, is formed between the flange section 733a of the rectangle, which configures the double supporting section 733 of the first member 730, and the rectangular frame-shape support body 733b. By providing such a step for alignment of 733d, the flat bottom face 735a is formed and the side wall surface 735b is formed along with the step for alignment of 733d. Among these, the relative location regarding the direction of an optical axis of the first lens section 31 and the second lens section 21 can be adjusted with the bottom face 735a. In addition, the position adjustment of the first lens section 31 and the second lens section 21 in a direction perpendicular to the optical axis can be easily conducted with high precision by butting and positioning the side face of the flange section 23 of the second member 20 to the side wall surface 735a. Under the present circumstances, the second lens section 21 is placed under the condition where the second lens section 21 can be rotated on the frame shape supporting body 733b of the first lens section 31. Thereby, the rotational attitude of the second lens section 21 can be adjusted on the frame shape supporting body 733b, and the directivity of the aberration of the astigmatism and the coma of the second lens section 21 can be adjusted. Under the condition that adjustment of the rotation position of the second lens section 21 has been completed, the second lens section 21 is fixed onto the frame shape supporting body 733b by using UV cure type resin etc. by four bonded portions BP provided, for example on the periphery of the second lens section 21. In the above objective lens unit 710, the frame shape supporting body 733b can also be regarded as the portion, which extends the flange section 733a provided in the periphery of the first lens section 31.

An index FM, which has depression and projection, is formed at the proper place on the surface at the flange section 733a of the double supporting section 733. Such index FM shall include the information regarding the point of the gate, for example, at the time of manufacturing the first member 730 by injection molding. It can use for product control including the quality at the time of attaching the objective lens unit 710 to the optical pickup apparatus, for example, (refer to FIG. 3), by providing such index FM.

In the above objective lens unit 710, the undersurface 21a of the second lens section 21 is in the light source side, and projects from the top face 21b on an optical information recording medium side. Such a projection of the undersurface 21a becomes so remarkable as the numerical aperture NA of the side of the image of the second lens section 21 (optical-information-recording-medium side) becomes large. On the other hand, the second flange 23 is supported by the frame shape supporting body 733b on the undersurface. Therefore, since the undersurface 21a of the second lens section 21 will be arranged so that it may be placed into an opening AP3, which functions as a aperture of the frame shape supporting body 733b, it can reduce the projection amount in which the undersurface 21a of the second lens section 21 projects from the lower end of the double supporting section 733. Thereby, the objective lens unit 710 can be made into a thin shape, the assembly to optical pickup apparatus becomes easy and the miniaturization of optical pickup apparatus can be attained. Further, the opening AP3 of the frame shape supporting body 733b can be functioned as a aperture, and it can make it contribute to a miniaturization.

In addition, another lens section being the first lens section 31 shall not have a diffracting plane in consideration of the simplicity of the formation. In this case, the first lens section 31 will be used for, for example, CD, and the other lens section being the second lens section 21 will be used for DVD and BD (or for HD DVD), for example. In addition, it can also be dared to make the first lens section 31 side into one with a diffracting plane. In this case, the first lens section 31 will be used, for example, for CD, and DVD, and the other side of lens section being the second lens section 21 will be used, for example, for BD. Or it is also possible to utilize the first lens section 31 for CD, DVD, and for HD DVD, for example, and to utilize the second lens section 21, which is another objective lens section, for BD, for example. Above, with regard to the second lens section 21 for BD, it can also be formed with glass.

It is a basic form that the above objective lens unit 710 is dealt with where the second member 20 is fixed onto the first member 730. However, plural types of the second member 730 and plural types of the second member 20 are kept as an inventory and the combination of an inventory can be determined according to a customer's request, and joining the first member 730 and the second member 20 can also be performed before shipment.

FIG. 11 illustrates a side view illustrating the modification of the objective lens unit 710 illustrated in FIG. 10. In this case, beveling has been applied to the peripheral upper part and the lower part of the second flange 23, and beveling has been also applied onto the upper end edge of the frame shape supporting body 733b and a step for alignment of 733d, and the outside edge of the bottom face 735a. Thereby, in the bonded part BP, since it fully fills up with the adhesive bond AB and adhesion area can be increased, joining of the second member 20 becomes more certain. In addition, if the slope, which the bonded part BP beveled, is formed into the rough surface, strength of adhesive bonding can be increased.

Although the present invention was explained based on the embodiments, the present invention is not limited to the above-mentioned embodiments, and various modifications will be possible. For example, in the above-mentioned first embodiment, the first lens section 31 performs playback and record of the information on DVD or CD, and the second lens section 21 performs playback and record of the information on BD. However, it can also be considered as the embodiment, which performs playback and record of the information on BD by the first lens section 31, and performs playback and record of the information on HD DVD, DVD, and CD by the second lens section 21. In addition, it can also be considered as the embodiment, which carries out three kinds of information on HD DVD/DVD/CD by the first lens section 31, and reproduces and records the information on BD by the second lens section 21. Furthermore, it can also be considered as the embodiment, which performs playback and record of the information on DVD or CD by the first lens section 31, and performs playback and record of the information on HD DVD by the second lens section 21. Furthermore, it can also be considered as the embodiment, which performs playback and record of the information on CD by the first lens section 31, and performs playback and record of the information on DVD by the second lens section 21.

In addition, although the second member 20 shall be formed with a resin material, a glass material, or athermal resin with the above-mentioned embodiment, the second member 20 does not need to be a single component, which is formed of a single material. For example, the second member 20 can be configured by joining a glass lens and a plastic lens directly or indirectly (With regard to a concrete structure, refer to Unexamined Japanese Patent Application Publication No. 2005-38481, for example). In addition, the second member 20 can be configured by joining two plastic lenses directly or indirectly (With regard to the specific structure, Unexamined Japanese Patent Application Publication No. 2002-269749, for example).

In addition, with regard to the above-mentioned embodiment, in the optical pickup apparatus, the objective lens unit 10 is moved in the direction vertical to an optical axis with an actuator 73 to change the lens. However, a lens change can also be performed, without moving the objective lens unit 10. In this case, the optical system for leading laser light to both the lens sections 21 and 31 individually that configure objective lens unit 10 can be provided, or optical path switching device for switching, such as a mirror, can be provided on the optical path which reaches to the objective lens unit 10.

1. An objective lens unit for an optical pickup apparatus comprising:
(a) a first lens section,
(b) a first flange section positioned peripheral of the first lens section; and
(c) a support section which supports a second objective lens having a second lens section, provided in parallel to the first lens section with an optical axis different from that of the first lens section,
wherein the first lens section, the first flange section and the support section are integrally formed.

2. The objective lens unit of claim 1, wherein the second objective lens comprises a second flange section which is provided peripheral of the second lens section.

3. The objective lens unit of claim 2, wherein the support section supports a surface of the second flange section, the surface of which faces a light source.

4. The objective lens unit of claim 2, further comprising a holder which supports at least one of the first flange section, the second flange section and the support section.

5. The objective lens unit of claim 4, wherein the holder is integrally formed with at least one of the first lens section and the second lens section.

6. The objective lens unit of claim 1, wherein the second objective lens is fixed on the support section.

7. The objective lens unit of claim 1, wherein the support section further comprises an alignment member which aligns the second flange section with respect to the support section.

8. The objective lens unit of claim 7, wherein the alignment member comprises a mechanism which positions the second lens section with respect to an optical axis direction thereof and a direction orthogonal to the optical axis direction.

9. The objective lens unit of claim 1, wherein the first lens section and the second lens section are capable of respectively forming a spot-diameter different from each other.

10. The objective lens unit of claim 1, wherein the support section has a function of an aperture for the second lens section.

11. The objective lens unit of claim 1, wherein the second objective lens is formed with glass.

12. An objective lens unit for use in an optical pickup device comprising:
(a) a first member having a first lens section and a first flange section, which supports a periphery of the first lens section by being integrally formed with the first lens section; and
(b) a second member having a second lens section and a second flange section, which supports a periphery of the second lens section by being integrally formed with the second lens section,
wherein the first flange section supports the second member so that the second lens section adjoins the first lens section.

13. The objective lens unit of claim 12, wherein the first flange section supports a surface of the second flange section, the surface of which faces a light source.

14. The objective lens unit of claim 12, further comprising a holder which supports at least one of the first flange section and the second flange section.

15. The objective lens unit of claim 14, wherein the holder is integrally formed with at least one of the first lens section and the second lens section.

16. The objective lens of claim 12, wherein the second objective lens is fixed on the first flange section.

17. The objective lens unit of claim 12, wherein the first flange section further comprises an alignment member which aligns the second flange section with respect to the first flange section.

18. The objective lens unit of claim 17, wherein the alignment member comprises a mechanism which positions the second lens section with respect to an optical axis direction thereof and a direction orthogonal to the optical axis direction.

19. The objective lens unit of claim 12, wherein the first lens section is capable of forming a spot-diameter different from that of the second lens section.

20. The objective lens unit of claim 12, wherein the first flange section has a function of an aperture for the second lens section.

21. The objective lens unit of claim 12, wherein the second objective lens is formed with glass.

22. An image pickup device comprising:
(a) the objective lens unit of claim 1; and
(b) an optical device in which information is read from a first optical information recording medium, or information is written to the first optical information recording medium through the first lens section, and information is read from a second optical information recording medium, or information is written to the second optical information recording medium through the second lens section.

23. The image pickup device of claim 22, further comprising a drive device which displaces the first and second lens sections by driving the objective lens unit.
